(19) United States
(12) Patent Application Publication
(10) Pub. No.: US 2007/0226950 A1
(43) Pub. Date: Oct. 4, 2007

(54) Vacuum loader with louvered tangential cyclone separator

(76) Inventor: Thomas M. Demarco, Woodstock, IL (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/726,935

(22) Filed: Mar. 23, 2007

Related U.S. Application Data
(63) Continuation-in-part of application No. 10/389,792, filed on Mar. 17, 2003, now Pat. No. 6,936,085.
(63) Continuation-in-part of application No. 11/162,024, filed on Aug. 25, 2005.
(63) Continuation-in-part of application No. 11/435,661, filed on May 17, 2006.

(51) Int. Cl. B01D 50/00; A47L 5/14

(52) U.S. Cl. 15/345; 55/324

(57) ABSTRACT

A tangential cyclone separator includes a support, a first sidewall, a second sidewall, and tube. The first sidewall extends away from the support and,includes a plurality of louvers each having a louver width and an inner edge. The plurality of inner edges define at least a portion of a first circle. The plurality of louvers are,spaced apart about the first circle. Each louver width defines a louver direction, and each louver direction and the first circle define a louver intersection. Each louver intersection and the first circle define a louver tangent line. Each louver tangent line is associated with a respective louver direction, where each louver tangent line and associated louver direction share a common louver intersection. Each louver direction and associated louver tangent form a louver angle, wherein each louver angle is approximately between 10° and 60°. The second sidewall extends upwardly from the support and includes an opening. The tube is connected to the opening and extends generally tangentially to the first circle.

### CROSS REFERENCE TO RELATED APPLICATIONS

This application is a continuation-in-part of U.S. patent application Ser. No. 10/389,792, filed Mar. 17, 2003, now U.S. Pat. No. 6,936,085 that issued on Aug. 30, 2005 and is entitled “Vacuum Loader”; U.S. patent application Ser. No. 11/162,024 filed Aug. 25, 2005 and entitled “Vacuum Loader”; and U.S. patent application Ser. No. 11/435,661, filed on May 17, 2006 and entitled “Vacuum Loader with Filter Doors.”

### FIELD OF THE INVENTION

The following disclosure relates to a vacuum loader and in particular to a pre-separator disposed in the vacuum loader.

### BACKGROUND OF THE INVENTION

This invention pertains to machines for removing or transfer dry and wet liquid particulates, and more particularly, to an industrial vacuum cleaner, vacuum loader, pneumatic conveyor, or industrial dust collector.

In industry, voluminous amounts of particulate matter, debris, and waste are emitted during machining, foundry, milling, shipment, warehousing, assembling, fabricating, and other manufacturing operations. Particulates of dust emitted during a manufacturing operation can include metal slivers, plastic chips, wood shavings, dirt, sand, and other debris. Dust accumulates on floors, machines, packaging materials, equipment, food and personnel. Dust is carried and circulated in the air and can be injurious to the health and safety of operating personnel and other on site employees. Dust can damage, erode, and adversely effect the efficiency and operability of equipment. It can also create a fire hazard and cause explosions in some situations, such as in grain elevators. Voluminous amounts of dust can pollute the atmosphere. Dust may also impair the quality of the products manufactured.

Dust emissions are not only dangerous and troublesome, but are particularly aggravating and grievous where relatively dust-free conditions and sterile environments are required, such as in medical supply houses, the electronics industry, and in food-processing plants.

Over the years a variety of vacuum loaders, industrial dust collectors and other equipment have been suggested for removing industrial dust and debris and for other purposes. These prior vacuum loaders, dust collectors and equipment have met with varying degrees of success.

It is, therefore, desirable to provide an improved vacuum loader, pneumatic conveyor, or industrial dust collector which overcomes most, if not all, of the preceding problems.

### BRIEF DESCRIPTION OF THE DRAWINGS

FIG. 1 is a simplified schematic of a vacuum loader.

FIG. 2 is a perspective view of a vacuum loader having a filter compartment with side access doors;

FIG. 3 is a left side view of the vacuum loader;

FIG. 4 front view of the vacuum loader with a diagrammatic illustration of the side access doors;

FIG. 5 is a back view of the vacuum loader;

FIG. 6 is a top plan view of view of the vacuum loader

FIG. 7 is a perspective view of a tangential cyclone separator looking from underneath.

FIG. 8 is a bottom view of the tangential cyclone separator.

FIG. 9 is a side view of the tangential cyclone separator taken along line 9-9 in FIG. 7.

### DETAILED DESCRIPTION OF THE INVENTION

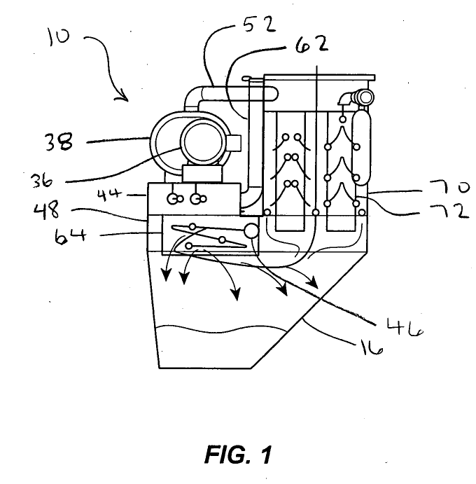

FIG. 1 is a greatly simplified schematic of an vacuum loader 10 with a frame assembly 12 supporting several components. The vacuum loader 10 includes a primary inlet conduit 46, a solids-gas separator 64 disposed in a solids-gas separator compartment 48, a hopper 16, a filter housing 70 that houses a plurality of air filters 72, a blower line 52, a vacuum motor 36 and air blower 38, a sound attenuating device 44, and a exhaust pipe 62. In use, dusty air is pulled in through the primary inlet conduit 46 and into the solids-gas separator 64. The solids-gas separator 64 swirls the air such that particulate is discharged by gravity downwardly into the hopper 16. The partially dedusted air then travels up through the filters 72 which remove substantially all remaining dust particulate. The dedusted air then travels through the blower line 52, down through the air blower 38, through the sound attenuating device 44, and then is discharged into the atmosphere through the exhaust pipe 62. The following is a more detailed description of the vacuum loader 10, and, in particular, the solids-gas separator 64.

Frame Assembly

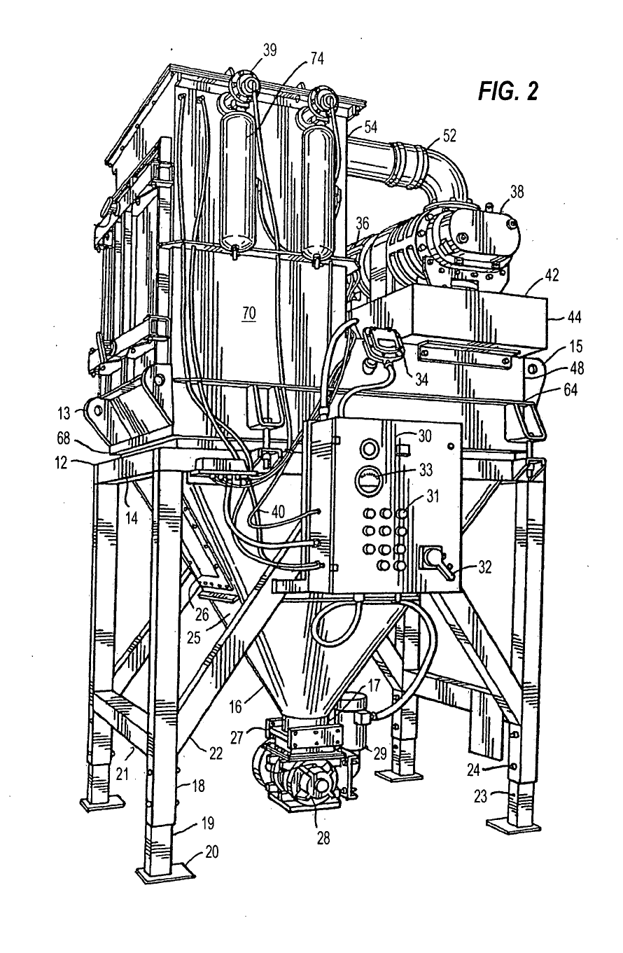

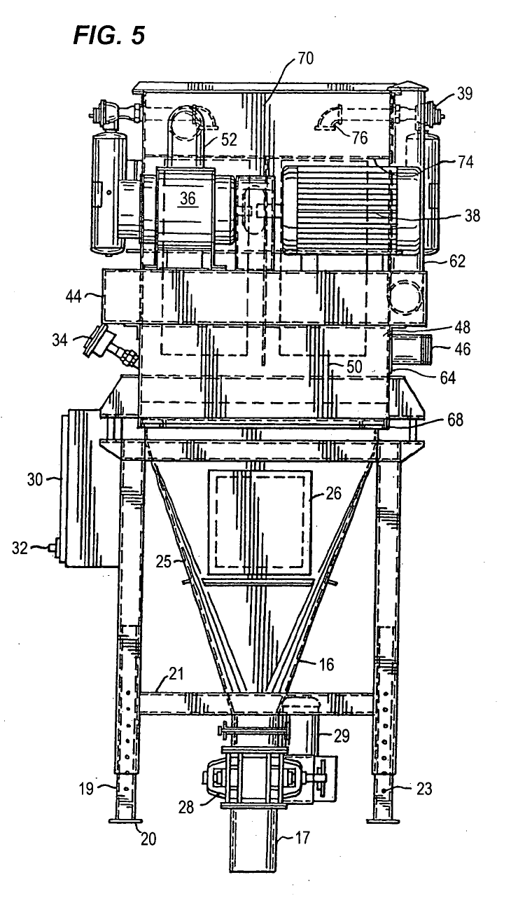

The vacuum loader 10 depicted in FIGS. 2-6 is an example of a heavy-duty vacuum-operated machine, industrial dust collector, vacuum cleaner, vacuum loader, vacuum conveyor and/or pneumatic conveyor. The vacuum loader 10 can efficiently remove, collect, and safely dispose or convey air-borne particulate matter, debris, and waste. The vacuum loader 10 can be made of steel or other metal. Other materials can be used. The vacuum loader 10 includes a frame assembly 12 with a base 14. The frame assembly 12 can be equipped flanged plates 13 and 15 (FIG. 2) with openings therein and/or with forklift-channels for receiving tines of a forklift truck. The frame assembly 12 can have telescoping upright legs 18, 19 with feet 20 and support members such as lateral bars 21 and diagonal braces 22. The telescoping legs 18, 19 can be extended or retracted to adjust the height of the legs 18, 19 and frame assembly 12. The legs 18, 19 have bolt holes 23 that receive bolts 24 and nuts to securely bolt the legs 18, 19 at the desired height. The frame assembly 12 could also include a skid with a coupling or tow bar for coupling and attachment to a railway car, truck or other vehicle. The frame assembly 12 can include wheels or casters mounted on the underside of the feet 20 to make the vacuum loader 10 mobile, portable, moveable, and towable.

The frame assembly 14 supports the hopper 16 such as a bin, end dump hopper, or other structure for gathering the particulate. In the depicted example, the hopper 16 is positioned below and supports the solids-gas separator compartment 48. The hopper 16 is also positioned below and supports the filter housing 70. The hopper 16 receives and collects the large particulates of dust removed by the solids-gas separator 64 and the smaller particulates (fines) removed by the air filters 72. Preferably, the hopper 16 has a lower portion with a manual or power-operated slideable valve to discharge the collected particulates (particles) of dust from inside the hopper 16. In this example, the hopper includes a downwardly inclined frustoconical portion 25 and a hopper outlet 17 at a bottom end of the hopper 16. The hopper outlet 17 can include a downwardly facing discharge pipe, a discharge door 26, a cutoff gate 27, and a rotary airlock valve 28 operatively connected to and controlled by a motor 29. The bin can be a stationary bin, a moveable bin, a portable bin, and/or a towable bin. A pneumatically-operated expansion bellows can be positioned on bellows support pads of the frame assembly 12 to raise the hopper 16 during assembly.

A control panel 30 can be mounted on the frame assembly 12. The control panel can have buttons 31, control knobs 32, and gauges 33 to control, activate, and deactivate a high level control 34 comprising an indicating gauge with a display screen, the motor 29 which drives and controls the rotary airlock valve 28, the vacuum motor 36, the air blower 38, air injectors 39, etc. via wires 40 or conduits. The control panel 30 can also be connected to a sensor and limit switch in the hopper 16 to automatically shut off the vacuum motor 36 or air blower 38 when the discharged collected dust in the hopper 16 has reached a preselected level. The control panel 30, which when energized and activated, provides voltage and power for the operation of a solenoid valve connected to a vacuum breaker 45, as well as solenoid air valves connected to a circuit controlling the filter cartridge's reverse pulse cleaning assembly. The electrical control panel 30 can be equipped with a air blower gauge, vacuum differential gauges, a filter differential gauge, switches, start/stop push buttons, a cartridge filter cleaning pulse timer circuitry package, indicating lights, relays, and other components, gauges, and devices.

Blower Assembly

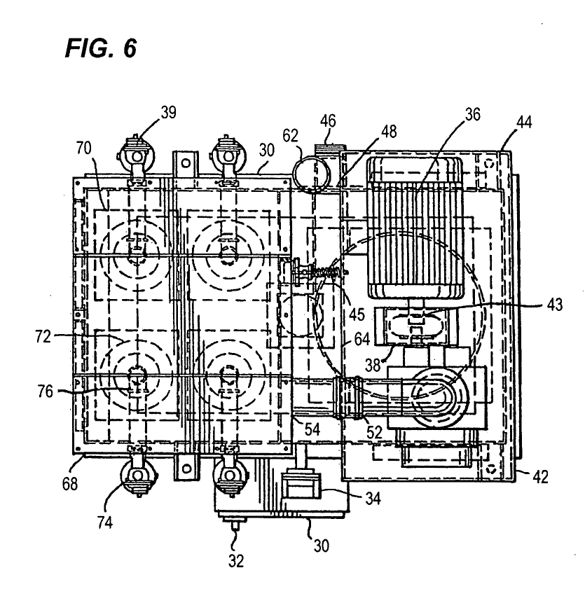

The vacuum motor 36 (FIG. 2) and air blower 38 can be mounted on a support housing 42 of the sound attenuating device 44. The vacuum motor 36 is operatively coupled to and drives the air blower 38 by a drive coupling 43 (FIG. 6) such as a drive shaft or drive belts. The air blower 38 can include a compressor, air blower, turbine, regenative (regen), or fan. The vacuum loader 10 can also be equipped with a vacuum breaker 45 providing a relief valve.

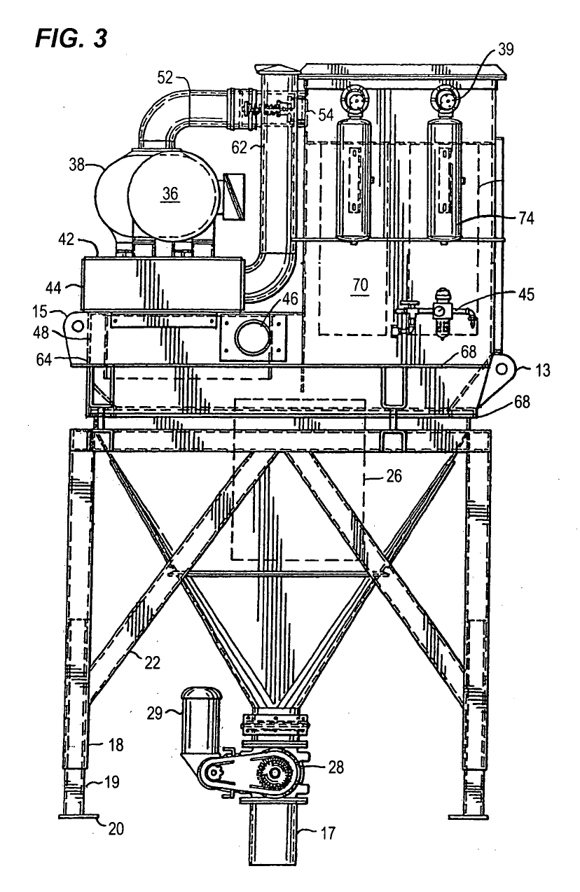

The air blower 38 creates a vacuum (suction) to draw dust and direct influent dusty air (air laden with particulates of dust) comprising the dusty gas stream through one or more inlet conduits, such as through a primary inlet conduit 46 (FIGS. 3-5) and an optional secondary inlet conduit. The primary inlet conduit 46 and optional secondary inlet conduit provide at least one material inlet port into a solids-gas separation (separating) compartment 48 containing one or more solids-gas separators 64. A flexible, elongated intake hose or metal air duct tubing, with an optional nozzle or hood, can be connected to the primary inlet conduit 46 to facilitate collection of the particulate material. As will be described more fully, in the depicted example, the primary inlet conduit 46 is tangential to the solids-gas separation compartment 48 and the solids-gas separator 64 contained therein. The primary inlet conduit 46 directs the flow of the influent dusty gas streams into the solids-gas separator 64, which creates a turbulent or swirling action of the dusty gas streams.

The air blower 38 can be connected to the overhead blower line 52 (FIG. 2), which in turn is connected to a filter housing outlet 54 of the upper portions of the filter housing 70. The air blower 38 can also be operatively connected to and communicate with an exhaust pipe 62 that emits the dedusted purified clean gas stream (air) to the surrounding area or atmosphere.

The vacuum loader 10 can be equipped with a sound attenuating device 44 (FIGS. 2-5) such as a muffler (FIG. 2) that can be connected to the air blower 38 and the exhaust pipe 62 to attenuate, muffle, suppress, and decrease noise and vibrations from the air blower 38 and vacuum motor 36, and dampen the noise and sound of the purified gases passing and being discharged through the exhaust pipe 62. The muffler 44 can be constructed as described in applicant's U.S. Pat. No. 4,786,299 which is hereby incorporated by reference.

Solids-Gas Separation Compartment

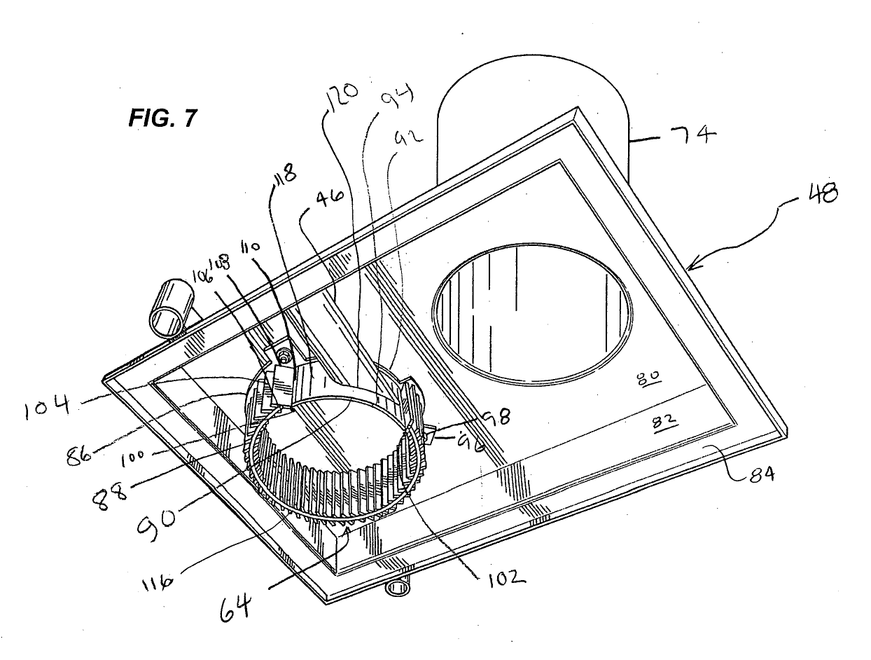

The solids-gas separation compartment 48 is a housing in fluid communication with both the hopper 17 and the filter housing 70 and houses the tangential cyclone separator 64 and the primary inlet conduit 46. As shown in FIGS. 7-9, the solids-gas compartment includes a top wall 80 and a plurality of sidewalls 82 extending downwardly from the top wall 80. A flange 84 extends outwardly from the bottom of the sidewalls 82 that can mate with an upper flange of the hopper 16. Further, a gasket (not shown) can be disposed between the flanges to provide a substantially air-tight connection between the solids-gas separation compartment 48 and the hopper 16. A filter chamber 74 extends upwardly from the top wall 80 of the solids-gas separation compartment 48. The air filters 72 are not shown in this view.

The primary inlet conduit 46 is tube that extends linearly and inwardly from a sidewall 82 of the solids-gas separation compartment 48 to the cyclone separator 64. Dusty air from the interior of a machine shop may be sucked into the primary inlet conduit 46 and delivered to the tangential cyclone separator 64.

The tangential cyclone separator 64 (referred to hereafter as the preseparator) includes a support 86, a first sidewall 88 extending downwardly from the support 86, and a second sidewall 90 also extending downwardly from the support 86. The preseparator 64 has a top side 92 and a bottom side 94. In this example the support 86 is a plate generally in the shape of a circle and includes three tabs 96 extending outwardly. The tabs 96 include through holes 98 enabling bolts or screws to mount the preseparator 64 to the top wall 80 of the solids-gas separation compartment 48. Other structure and methods for mounting the support plate 86 of the preseparator 64 to the top wall 80 of the solids-gas separation compartment 48, such as welding or bonding, can be used.

The first sidewall 88 is generally in the shape of a portion of a circle and includes a first endpoint 100 and a second end point 102. The first sidewall 88 includes a plurality of louvers 104 extending downwardly from the support plate 86. Each of the louvers 104 is in the shape of a rectangle with a bottom wall 106, a top wall 108, and an inner side wall 110. Each of the top walls 108 are fixed to the support plate 86, and each of the louvers 104 has a width and a height that is longer than the width. Each bottom wall 106 defines a louver direction D.

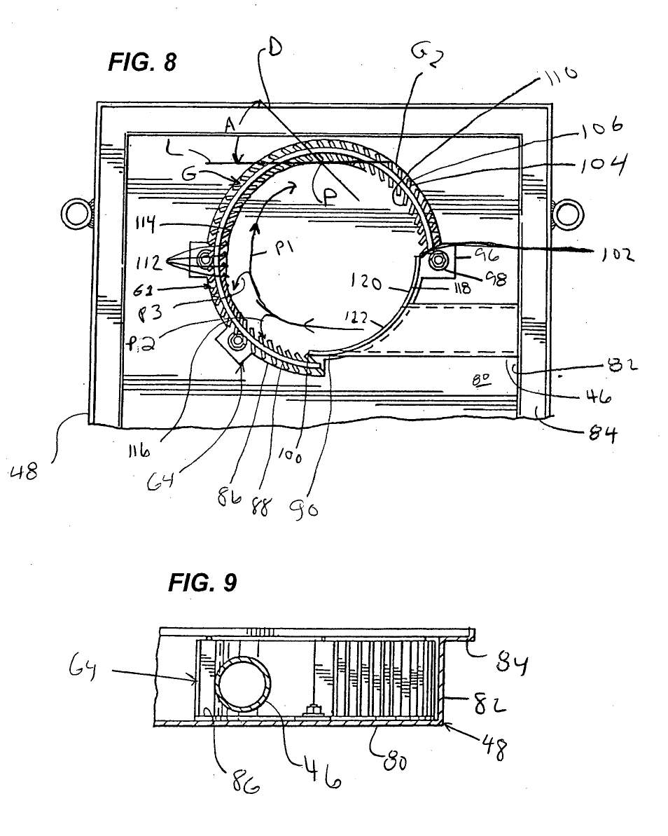

As shown in FIG. 8, in a plan view of the preseparator 64, edges of the inner side walls 110 form points 112 that lie on a first circle 114. Each of the louver directions D intersect the first circle 114 at an intersection point P. Tangent lines L that are each tangent to the circle extend through each intersection point P. Each tangent line L is associated with the respective louver direction D, where the tangent line L and the louver direction D share an intersection point P. For each louver 104, each louver direction D and each louver tangent line L associated with that louver direction D form an angle A that is between 0° and 90°. Preferably, the angle A for each louver 104 is between approximately 10° and 60°, and more preferably approximately 45°. The term “approximately” is used herein to reflect manufacturing tolerances and variability.

Each of the louvers 104 are spaced from each other such that gaps G are formed between adjacent louvers 104 in the first sidewall 88. The gaps G provide open areas in the first sidewall 88 that can extend from greater than 0° to 360°, preferably 60° to 300°, and most preferably 270° around the first circle. The size of the gaps G between adjacent louvers 104 can decrease with angular distance from the primary inlet conduit 46.

The support plate 86 covers the top side 92 of the preseparator 64, and in particular, covers the first circle 114 on the top side 92. The first circle 114 is open on the bottom side 94 of the preseparator 64.

A portion of an annulus 116 can be disposed on the bottom sides 106 of each of the louvers 104. The annulus 116 connects the louvers 104 together to strengthen the construction of the preseparator 64. The louvers 104 can be connected to the annulus 116 by welding or other known method.

The second sidewall 90 can be a section of a cylinder 118. In contrast to the first sidewall 88, the second sidewall 90 can be imperforate. The cylinder section 118 can form a portion of a second circle 120 that is concentric with the first circle 114. The cylinder section 118 can be disposed approximately on the first circle 114 such that the first circle 114 and the second circle 118 have approximately same diameter and are thus approximately the same circle. The cylinder section 118 can extend from the first endpoint 100 of the first sidewall 88 to the second endpoint 102 of the first sidewall 88. The second sidewall 90 includes an opening 122 from which the primary inlet conduit 46 extends. The primary inlet conduit 46 extends generally tangentially from the first circle 114.

The preseparator 64 can be relatively short with a height of about twice the diameter of the primary inlet conduit 46, i.e. the ratio of the height of the preseparator 64 to the diameter of the primary inlet conduit 46 can be 2:1, e.g. a 12″ tall preseparator 64 is used with a 6″ primary inlet conduit 46. In contrast, conventional tangential cyclones with cones are relatively tall with a height of about ten times (10 fold) the diameter of the inlet hose.

The preseparator 64 provides gross separation to remove large particulates (particles) of dust from an influent dusty gas stream (e.g. dust laden air) to obtain a grossly separated effluent dusty stream having a lower concentration of particulates of dust by weight than the influent dusty stream. The preseparator 64 separates the large particulate from the air stream by way of the different kinetic energies and inertias of the air and the particulate. The vacuum motor 36 and air blower 38 provide a low pressure within the solids-gas separation compartment 48 such that a dusty gas stream is sucked into the compartment 48 through the primary inlet conduit 46. As the air stream enters the preseparator 64, the layout of the louvers 104 in a circle tends to direct the air stream into a swirling cyclone-like path P1. However, due to the gaps G between the louvers 104 and the low pressure in the solids-gas separation compartment 48, the air in the air stream is also sucked between the louvers 104 through the gaps G and out from inside the preseparator in various exit paths P2, P3. Due to the low kinetic energy and inertia of air, and due to the low pressure in the solids-gas separation compartment 48, air is able to make the relatively sharp turn from the swirling path P1 to the exit paths P2, P3. However, the large particulates have a much higher kinetic energy and inertia and cannot make the turn from the swirling path P1 to any of the exit paths P2, P3. Instead, the large particulates remain in the swirling path PI, but are continually pulled downwardly by gravity until they are below the preseparator and are disposed in the hopper 16.

Further, the gaps G between the louvers 104 can decrease about the first circle 114 in the direction of path P1. In other words, gap G1 is wider than gap G2, for example. Accordingly, as the air travels about the circle, and a portion of the air travels through the various exit paths P2, P3, less air is swirling inside the preseparator 64. Therefore, the smaller gaps G maintain the speed of the air through the louvers 104 throughout the preseparator 64. In other words, the speed of the air at path P2 is the same as the speed of the air through path P3. This maintains a constant kinetic energy of the air through the gaps G.

The vacuum loader 10 with a louvered preseparator 64 provides a heavy duty, vacuum operated machine, dust collector, industrial vacuum cleaner, vacuum loader, and conveyor to efficiently remove, collect, and safely dispose of particulate matter, debris, and waste. The louvered preseparator 64 makes a gross cut and partially dedusts the dusty influent air, gas and/or liquid. The louvered preseparator 64 can be oriented and arranged to direct and blow the dusty air, gas and/or liquid counterclockwise or clockwise, so that the dusty air, gas and/or liquid flows downwardly through the solids gas separation compartment 48, laterally through an upper portion of the bin or hopper 16, and upwardly through a single filter compartment or multiple filtering compartments 70. The louvered preseparator 64 minimizes turbulence, clogging and re-entrainment of particulates.

Alternatively, the vacuum loader 10 can include a preseparator(s) of different structure. For example, the vacuum loader can include a perforated plate or foraminous cyclone separator described in applicant's U.S. Pat. No. 6,936,085, which is hereby incorporated by reference. The tangential cyclone separator can have angular perforations, such as described in applicant's U.S. patent application Ser. No. 11/162,064 which is also hereby incorporated by reference. Instead of or in addition to the perforated tangential cyclone separator, the solids-gas separator can comprise a perforated, foraminous curved barrier wall or perforated, foraminous angled impact plate separator (strike plate). The perforated tangential cyclone separator, curved barrier wall, and impact plate separator all provide a deflector(s) comprising an impingement surface(s) with angular perforations which change the direction of the incoming dusty gas stream and grossly separates and removes the larger particulates of dust from the influent dusty gas stream.

Filter Compartment

The partially dedusted gas stream can exit the tangential preseparator through the paths between the slats, or out the bottom of the preseparator and flow upwardly through open bottoms 68 (FIGS. 2-6) of the filter compartment 70 or multiple filter compartments, such as described in applicant's U.S. Pat. No. 6,569,217 which is hereby incorporated by reference. Each filter compartment contains one or more filters 72 (FIGS. 6-8), preferably a set, series, or array of filters, such as four upright tubular filters. The filter compartment contains a plurality, set, or array of canister filters (annular, tubular or cartridge filters) 72 (FIGS. 6-8).

The partially dedusted gas stream of air can pass (flow) upwardly and be filtered by filters 72 in the filter compartment 70 to remove most of the remaining smaller particulates (fines) of dust in the dusty stream. The partially dedusted gas stream can flow upwardly, annularly, and laterally through each filter 72 of the filter compartment 70 to remove substantially all the remaining particulates of dust. In the illustrative embodiment, the filter compartment 70 contains a set of four canister filters 72 which are positioned in a circular array. While the preceding arrangement is preferred for best results, more or less filters or different types of filters can be used, if desired. The filtered dedusted air can pass (flow) upwardly and exit and be discharged from the filter compartments 70 through the filter outlet 54 (FIG. 2). The filtered air can be drawn through the blower line 52 by the air blower (blower) 38 and can be discharged to the surrounding area and atmosphere by the exhaust pipe 62. A discharge outlet conduit 54 (FIG. 2) can be connected to and communicate with the filter compartment 70 to provide an outlet and passageway through which the purified, dedusted and filtered air is drawn from the filter compartment via the blower line 52 into the air blower 38 and muffler 44 for discharge via the exhaust pipe 62 to the atmosphere or area surrounding the vacuum loader 10.

The vacuum loader can have multiple filter (filtering) compartments 70 with two or more filter (filtering) chambers. Advantageously, each filtering compartment(s) 70 are positioned generally along side and is spaced laterally away from the preseparator 64 and in offset relationship thereto, rather than in vertical alignment or completely above the preseparator 64. While tubular filters 72 are preferred for more effective filtering, in some circumstances it may be desirable to use one or more other types of filters, such as Hepa-type filters, bag-type filters, box-type filters, envelope filters, flat filters, or conical filters. Other types of filters can also be used, if desired. Each filter (filtering) compartment can have a pressure (vacuum) relief valve.

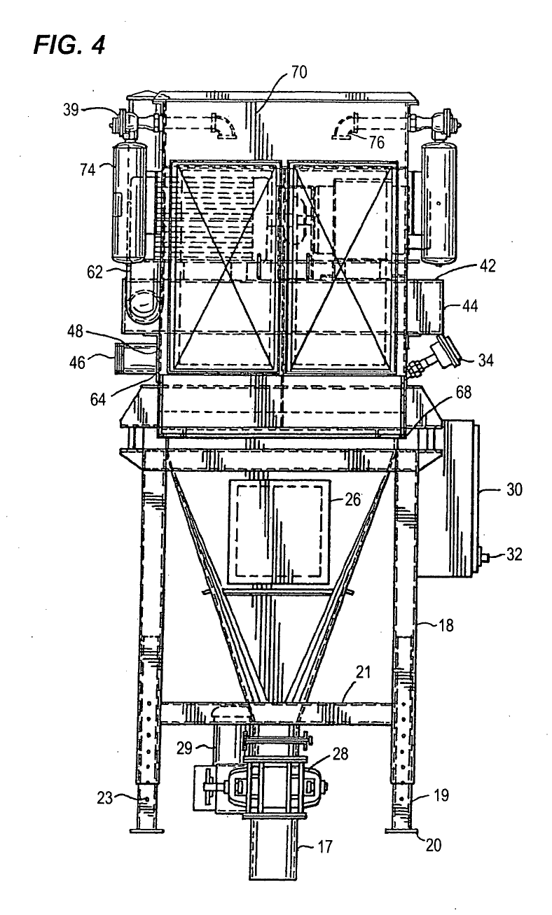

Reverse pulse filter cleaners comprising air injectors 39 (FIGS. 2-6) can be mounted and extend to the interior of the upper air chamber of the first filtering compartment 70 to periodically inject intermittent blasts comprising pulses of compressed clean air upon the inside (interior) of the filters 72 to help clean the filters 72. The injectors 39 can be connected by pneumatic tubes or conduits to an air supply source 74, such as compressed air tanks comprising compressed air canisters, or an auxiliary compressor. In the illustrative embodiment, there is a circular array or set of four upright compressed air canisters (compressed air tanks) 74 mounted about the exterior surface of the cylindrical upright wall of the filtering compartment 72 and there is a circular set or array of four downwardly facing, overhead air injectors 76 (FIGS. 4-6) positioned above the centers of the filters 72 and connected to the compressed air canisters 74 to sequentially or simultaneously inject pulses of compressed air into the center of the tubular filters 72 to shake loose the dust collected, accumulated, or the outside of the filter walls. More or less air injectors 76 and compressed air canisters 74 can be used. While the illustrated arrangement is preferred for best results, a different arrangement can be used, if desired. The filtered removed dust collected and accumulated on the bottom of the first filtering (filter) compartment can be discharged into the hopper 16 when the air blower 38 is turned off or by actuation of the control panel 30 and/or when the discharge door or bottom of the first filter compartment 70 is open. The open bottoms of the filter compartments 70 can provide filter discharge openings to discharge the filtered and removed particulates of dust (fines) into the hopper 16.

In the preferred embodiment, the air injectors 76 are positioned at an elevation above the filters 72, air blower 38, vacuum motor 36, and preseparator 64. In some circumstances, it may be desirable to use other types of filter cleaning equipment, such as manual or powered mechanical shakers and vibrators.

Operation of Vacuum Loader

In operation, air laden with entrained particulates of debris, waste and other dust is drawn by the blower through the primary intake conduit 46 into the preseparator 64 in the solids-gas separation compartment 48. The preseparator 64 swirls the dusty air tangentially about the first circle 114 of the preseparator 64 and ejects the partially dedusted air upwardly into the filter compartment 70. Preferably, the preseparator 64 kinetically and centrifugally separates most of the carryover dust from the incoming air stream. The cleaner, partially dedusted air can be drawn (sucked) radially outwardly through the gaps G between the louvers 104 of the preseparator 64, where it flows upwardly and is filtered by the high efficiency cartridge filters 72. The filters 72 can filter the particulates (dust) to under 1 micron, preferably at an efficiency of about 99.5% at about 0.33 microns. Collected dust on the surface of the filters 72 can be cleaned by variable pulse speed, reverse-air pulse injectors 39. The removed particulates are discharged by gravity downwardly into the hopper 16 through the bottom outlet of the solids-gas separation compartment 48.

The vacuum loader 10 can incorporate a unique two stage separator system which provides for highly effective separation of the vacuumed dust-laden product (wet, dry, or fibrous, as well as liquids and slurries) thereby providing customers with versatile, effective, and substantially trouble-free dust collecting, vacuum cleaning, and loading. The vacuum loader 10 can provide capabilities for long distance vacuuming of very light fibrous materials, such as fiberglass to lumps, chunks, soda ash, steel shot and talconite pellets. The vacuum loader 10 can further effectively, efficiently, and safely collect and discharge fibers, dust laden liquids, dry dusty materials, contaminated sand and soil, slivers, chips, granular material, pellets, chunks, powders, slurries, liquids, debris, coal and other minerals, soda ash, metals, dense and heavy material, such as steel shot and talconite pellets, waste, and other particulate material. Additionally, the vacuum loader 10 provides a total vacuuming system which is under continuous negative pressure from the primary inlet conduit 46 to exhaust pipe 62 during all vacuum cycles throughout the operating day and shift.

Among the many advantages of the preceding industrial vacuum loader 10 comprising dust collectors, pneumatic conveyors, vacuum conveyors, and industrial vacuum cleaners are: Superior vacuuming and removal of dust, particulate matter, debris and waste; convenient filter side doors for ready ingress and egress of the filters in the filter compartment to permit easy insertion, removal, inspection, or maintenance of the filters; better solids-gas separation; enhanced air purification; excellent dedusting; greater efficiency of operation; more economical to manufacture and operate; enhanced air purification; greater decreased operator exposure to dust; good load-carrying collection capacity; flexibility and better adaptability for moveable, towable, portable and stationary operations; superb performance; easy to use; dependable; quieter operation; easy to install, remove and repair; less maintenance; economical; efficient; and effective.

As used in this Patent Application, the term “dust” means particulate matter, debris and waste. The dust can comprise particulates of fiberglass, fibrous materials, powder, coal and other minerals, metal slivers and chips, sand, soda ash, steel shot, talconite pellets and other particulate material.

The term “fluid” as used herein means air and other gases and water and other liquids.

The terms “dedust” and “dedusted” as used herein mean removing a substantial amount of dust.

The term “fines” as used herein means small, minute, particulates.

The term “bulk” as used herein means the major portion of the vacuumed materials.

A more detailed explanation of the invention is provided in the following description and appended claims taken in conjunction with the accompanying drawings.

Although embodiments of the invention have been shown and described, it is to be understood that various modifications and substitutions, as well as rearrangements of parts, components, equipment, apparatus and process steps, can be made by those skilled in the art without departing from the novel spirit and scope of this invention.

1. A tangential cyclone separator, comprising:
a support;
a first sidewall extending away from the support, the first sidewall including a plurality of louvers each having a louver width and an inner edge, the plurality of inner edges defining at least a portion of a first circle, the plurality of louvers being spaced apart about the first circle, each louver width defining a louver direction, each louver direction and the first circle defining a louver intersection, each louver intersection and the first circle defining a louver tangent line, each louver tangent line being associated with a respective louver direction, where each louver tangent line and associated louver direction share a common louver intersection, each louver direction and associated louver tangent form a louver angle, wherein each louver angle is approximately between 10° and 60°;
a second sidewall extending upwardly from the support, the second sidewall including an opening; and
a tube connected to the opening and extending generally tangentially to the first circle.

2. The separator of claim 1, wherein the second sidewall is a portion of a cylinder.

3. The separator of claim 1, wherein the second sidewall defines at least a portion of a second circle.

4. The separator of claim 3, wherein the second circle is concentric with the first circle.

5. The separator of claim 4, wherein the second circle has the same diameter as the first circle.

6. The separator of claim 1, wherein the support comprises a plate that covers a top side of the separator.

7. The separator of claim 1, wherein the separator is open on a bottom side.

8. The separator of claim 1, wherein the support includes means for mounting the support.

9. The separator of claim 1, further comprising an annular ring mounted to bottom sides of the louvers.

10. The separator of claim 1, wherein the tube is generally tangential the inner edges of the plurality of louvers.

11. Vacuum loader, comprising:
a frame;
a hopper coupled to the frame;
a filter housing coupled to the frame;
a vacuum motor coupled to the frame;
an air blower coupled to the frame; and
a tangential cyclone separator coupled to the frame, the tangential cyclone separator including
a support;
a first sidewall extending away from the support, the first sidewall including a plurality of louvers each having a louver width and an inner edge, the plurality of inner edges defining at least a portion of a first circle, the plurality of louvers being spaced apart about the first circle, each louver width defining a louver direction, each louver direction and the first circle defining a louver intersection, each louver intersection and the first circle defining a louver tangent line, each louver tangent line being associated with a respective louver line segment, where each louver tangent line and associated louver line segment share a common louver intersection, each louver line segment and associated louver tangent form a louver angle, wherein each louver angle is approximately between 10° and 60°;
a second sidewall extending upwardly from the support, the second sidewall including an opening; and
a tube connected to the opening and extending generally tangentially to the first circle;
wherein the vacuum motor and air blower suck dusted air into the tangential cyclone preseparator to partially dedust the air and deposit dust into the hopper, through the filter to dedust the air, and push air out of the vacuum loader.

12. The vacuum loader of claim 11, wherein the second sidewall is a portion of a cylinder.

13. The vacuum loader of claim 11, wherein the second sidewall defines at least a portion of a second circle.

14. The vacuum loader of claim 13, wherein the second circle is concentric with the first circle.

15. The vacuum loader of claim 14, wherein the second circle has the same diameter as the first circle.

16. The vacuum loader of claim 11, wherein the support comprises a plate that covers a top side of the separator.

17. The vacuum loader of claim 11, wherein the separator is open on a bottom side.

18. The vacuum loader of claim 11, wherein the support includes means for mounting the support.

19. The vacuum loader of claim 11, further comprising an annular ring mounted to bottom sides of the louvers.

20. The vacuum loader of claim 11, wherein the tube is generally tangential the inner edges of the plurality of louvers.
